(19) United States
(12) Patent Application Publication
(10) Pub. No.: US 2002/0026864 A1
(43) Pub. Date: Mar. 7, 2002

(54) UKELELE TUNING MACHINE

(76) Inventor: Takao Gotoh, Isezaki-shi (JP)

Correspondence Address: TREXLER, BUSHNELL, GIANGIORGI,, BLACKSTONE, MARR, LTD., 36TH FLOOR, 105 WEST ADAMS STREET, CHICAGO, IL, 60603, US

(21) Appl. No.: 09/774,314

(22) Filed: Jan. 31, 2001

(30) Foreign Application Priority Data
Sep. 5, 2000 (JP) 2000-267968

(51) Int. Cl. G10D 3/14

(52) U.S. Cl. 84/304

(57) ABSTRACT

A ukulele tuning machine to be mounted on a head stock (A) of a ukulele and inserted into an aperture (1) provided therein, comprising: a hollow, cylindrical housing (2) having a top plate which has a shaft hole (4) at an off-centered position; a pinion shaft (3) having a pinion (3b) inside said housing (2) and connecting a tuning knob (10) outside said housing (2), said pinion and said tuning knob being placed interposing said shaft hole (4) of said housing (2) therebetween; a string post (7) having one and the other ends and including an internal gear (5) provided at said one end, which can rotatably engage with said pinion (3b) within said housing (2), and a string-fastening portion (6) formed at the other end; a collar (14) having a flange (3c) contacting the back of said internal gear (5) within said housing (2) and a threaded portion (14b) formed on a cylindrical body receiving said winding shaft (7) therethrough; a stopper means (15) for preventing said collar from slipping out, which is located and secured inside said housing (2) at the back of said collar (14); and a cylindrical nut (18) for engaging with said threaded portion (14b) of said collar (14) located inside said peg bead (A) to secure said housing (2) on said peg head (A).

### BACKGROUND OF THE INVENTION

1. Field of the Invention

The present invention relates to a ukulele tuning machine, which allows even a beginner in playing a ukulele to tune it finely with ease and is capable of reducing a slack of a string as far as possible once tuned.

2. Description of the Related Art

In general, a ukulele is required to have a small size and popularity with easy availability. In such the ukulele, a head portion having a tuning machine must be miniaturized and light-weighted as far as possible and the whole mechanism of the ukulele must be simplified and produced with a low cost. Thus, the tuning machine mostly used in the art has a string post for winding a string directly, which has a rotation ratio equal to that of a tuning knob as shown in FIGS. 4 and 5. That is, a bush 21, which is inhibited to rotate, is fixed on one end of an aperture 20 formed through a head stock A of a ukulele and a string post 23 is inserted rotatably into the bush 21 through a washer 22. The winding shaft 23 has a hole 23c formed near a distal end for inserting and fastening a string, a rectangular shaft 23a formed in the rear-half portion, and a threaded hole 23b at the axial center into which a knob-fixing screw described later is engaged.

A portion of the winding shaft 23 projected from the other side of the aperture 20 is inserted into a fixing bearing 25 through a toothed lock washer 24, and is further fitted into a bearing 27 and a knob 28 through a washer 26. In the center of the knob 28, a rectangular hole 28a, in which the rectangular shaft 23a of the winding shaft 23 can insert, and threaded hole 28b are formed. A knob fixing screw 30 is inserted into the threaded hole 28b through a washer 29 and the knob fixing screw 30 is engaged into the threaded hole 23b of the winding shaft 23.

In the tuning machine attached in the aperture of the peg head of the ukulele, a string is attached into the string-fastening hole 23c of the winding shaft 23, then the knob 28 is turned to tune the string. Once tuned, the knob fixing screw 30 is strongly engaged into the threaded hole 23b of the winding shaft 23 to fix the winding shaft 23 and the knob 28 onto the peg head so as to inhibit them from tuning. The winding shaft 23 and the knob 28 are directly connected together, so they have a rotational ratio of 1:1.

Where a ratio of an amount of wound string to an amount of rotations of the winding shaft is equal to 1:1, as in the case described above where the string is directly wound up by the winding shaft, a problem occurs. Because the winding shaft can not be fixed easily on a desired fixing position in the hole and thus the fine-tuning of the string is difficult for the beginners in playing ukuleles. Even if the winding shaft and knob can be fixed on the desired portion in the aperture of the peg head with the knob fixing screw, the fixing means is the screw formed concentrically with them, as the winding shaft may be rotated inversely due to continuous variations of the string tension during playing the ukulele to cause relaxation of the string disadvantageously.

On the other hand, with regard to the means for fixing the winding shaft onto the desired portion in the hole of the peg, i.e., the means for fine-tuning the string, a mechanism for facilitating the fine-tuning of the string is found in instruments such as guitars and banjos. The mechanism employs reduction gears such as a pair of worm and worm wheel, a pair of sun gears and planet gears or the like. It varies a ratio of an amount of rotations of the winding shaft to an amount of wound string to reduce the speed.

However, if these mechanisms are diverted to the ukulele as such, the peg head of the ukulele becomes large and loses the standard form of the ukulele. This worsens the feature of the ukulele and increases its weight. It also increases the cost and loses the original popularity of the ukulele.

It has been therefore required to provide such a ukulele tuning machine of which a head portion is miniaturized and light weight. The tuning machine can simplify the whole mechanism of a ukulele to reduce the cost, the tuning machine allows even a beginner in playing a ukulele to tune it finely with ease and is capable of reducing a slack of a string as far as possible once tuned through the use of reduction gears in a tuning mechanism.

### SUMMARY OF THE INVENTION

The present invention has been made to solve the above problems and is directed to a ukulele tuning machine, which comprises: a hollow, cylindrical housing having a top plate which has a shaft hole at an off-centered position; a pinion shaft having a pinion inside said housing and connecting a tuning knob outside said housing, said pinion and said tuning knob being placed interposing said shaft hole of said housing therebetween; and a string post having one and the other ends and including an internal gear provided at said one end, which can rotatably engage with said pinion within said housing, and a string-fastening portion formed at the other end.

Preferably, the ukulele tuning machine according to the present invention may further comprise: a collar having a flange contacting the back of said internal gear within said housing and a threaded portion formed on a cylindrical body receiving said winding shaft therethrough; a stopper means for preventing said collar from slipping out, which is located and secured inside said housing at the back of said collar; and a cylindrical nut for letting said winding shaft projected from one side of said aperture pass by said cylindrical nut and engaging with said threaded portion of said collar located inside said peg head so as to secure said housing on said peg head, when parts other than said housing of an assembly, which includes said housing, said pinion shaft, said winding shaft, said collar and said stopper means, are inserted into said one side of said aperture of said peg head.

Preferably, in order to realize a simple and low-cost construction as far as possible, the stopper means may comprise an inverted ring placed at the back of the collar inside the housing to prevent the collar from dropping out of the housing.

Other features and advantages of the invention will be apparent from the following description of the preferred embodiments thereof.

### BRIEF DESCRIPTION OF THE DRAWINGS

The present invention will be more fully understood from the following detailed description with reference to the accompanying drawings in which:

FIG. 1 is an exploded and partially sectioned perspective view showing a ukulele tuning machine of an embodiment according to the present invention;

FIG. 2 is a cross-sectional view of the main part showing the ukulele tuning machine of FIG. 1, which is mounted on a head stock of a ukulele;

FIG. 3A is a cross-sectional view showing a housing of the ukulele tuning machine of FIG. 1;

FIG. 3B is a cross-sectional view showing an internal gear of the ukulele tuning machine of FIG. 1;

FIG. 4 is an exploded side view showing an example of a conventional ukulele tuning machine; and

FIG. 5 is a cross-sectional view of the main part showing the ukulele tuning machine of FIG. 4, which is mounted on a head stock of an ukulele.

### DETAILED DESCRIPTION OF THE PREFERRED EMBODIMENTS

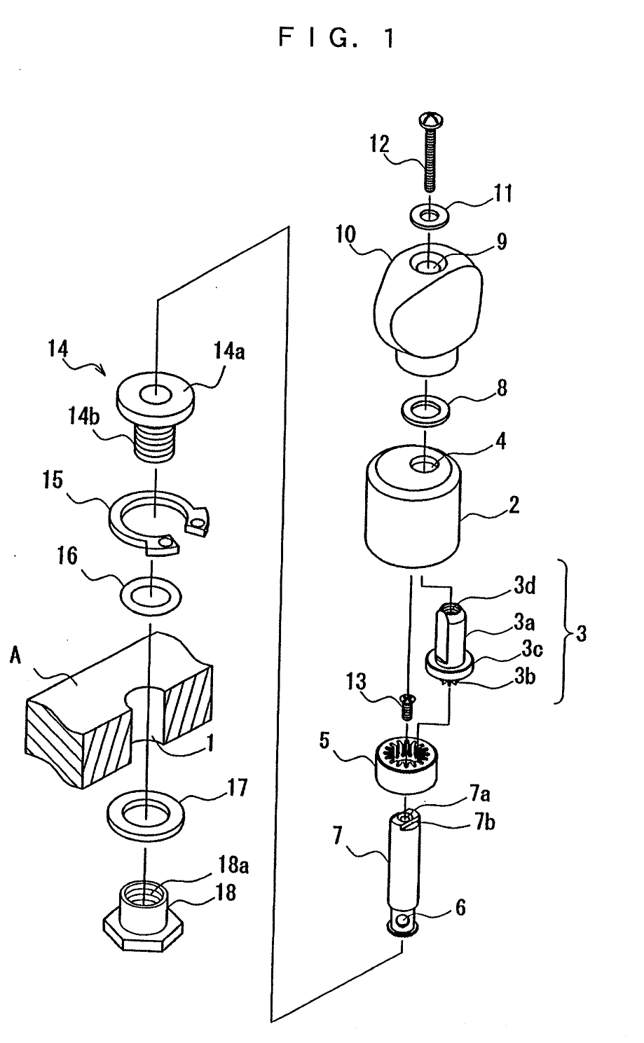

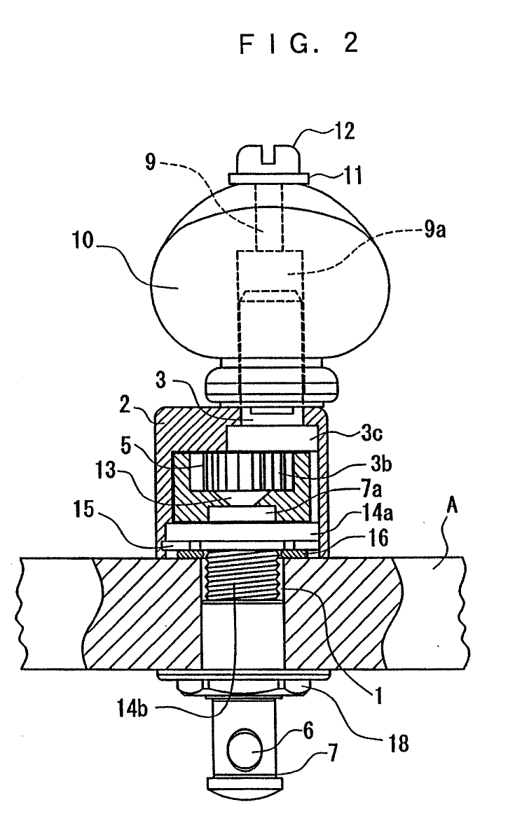

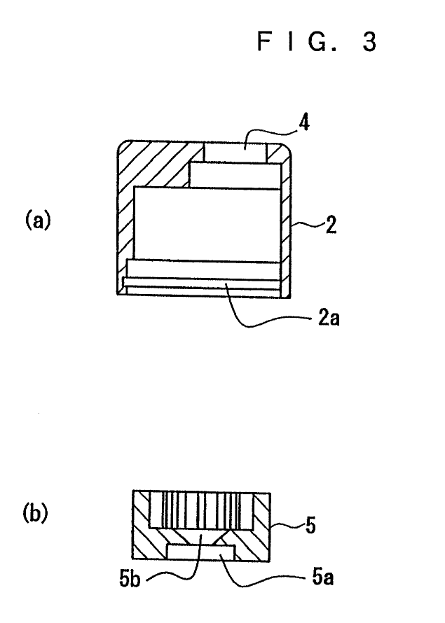

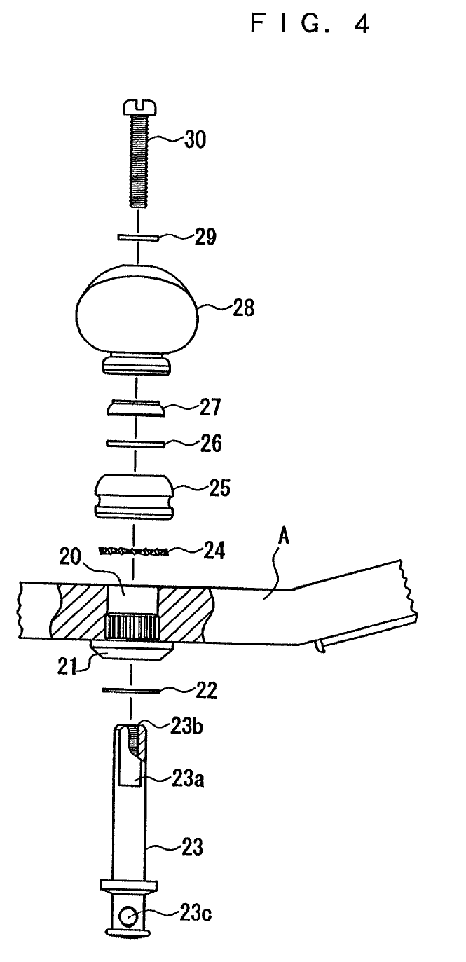

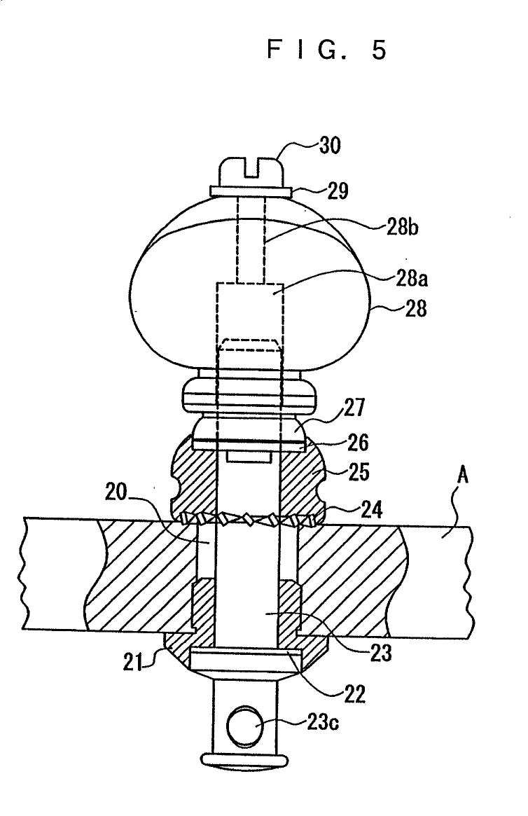

Referring now to the accompanying drawings, an embodiment of a ukulele tuning machine according to the present invention will be described. FIG. 1 is an exploded perspective view showing the tuning machine. FIG. 2 is an assembled cross-sectional view showing the tuning machine, which is mounted on a head stock of the ukulele. FIG. 3A is a cross-sectional view of a housing, and FIG. 3B is a cross-sectional view of an internal gear.

A head stock A of the ukulele has an aperture 1 formed therein for receiving a tuning machine. A hollow cylindrical housing 2 with a top plate is fixed on and covers one side of the aperture. The top plate has a shaft hole 4 formed at an off-centered position. A pinion shaft 3 has a shaft 3a that is inserted into the shaft hole 4. The pinion shaft 3 also has a flange 3c that is rotatably fitted in the shaft hole 4. The shaft hole 4 is formed as a two-steped concentric shaft hole with different depths so that the front surface of the flange 3c comes to be coplanar with the inner surface of the top plate of the housing 2.

The pinion shaft 3, inserted into the shaft hole 4, has a pinion 3b on the center of one surface of the flange 3c, which is engaged with an internal gear 5 of a string post 7 as described later. On the center of the other surface of the flange 3c, the shaft 3a, which comprises a rectangular shaft with a threaded hole 3d at the center, is integrally formed.

The winding shaft 7 has the internal gear 5 for engaging with the pinion 3b fixed at one end and a string fastening hole 6 formed at the other end. The internal gear 5 is rotatably contained inside the housing 2.

The winding shaft 7 has a screw hole 7a threaded at the center of one end and a rectangular shaft 7b formed at the circumference. A square groove 5a is formed in the central portion of the internal gear 5 and a threaded hole 5b is formed at the center of the square groove 5a. The rectangular shaft 7b is fitted into the square groove 5a and a flush screw 13 is engaged into the screw hole 7a through the hole 5b to secure the internal gear 5 with the winding shaft 7.

The shaft 3a, projected from the shaft hole 4 of the housing 2, is fitted through a synthetic resinous washer 8 into a tuning knob 10, which has at the center a threaded hole 9 and a rectangular hole 9a for receiving the shaft 3a. A screw 12 is engaged into the threaded hole 9 through a washer 11. As a result, the pinion shaft 3 and the knob 10 can be mounted on the housing 2 freely fastening to and relaxing from the top plate thereof.

The winding shaft 7 is inserted in turn into a hollow cylindrical collar 14, an inverted ring 15 and an O-ring 16. The collar 14 has a flange 14a for fitting into the housing 2 and an outer threaded portion 14b formed thereon. The inverted ring 15 fits the flange 14a of the collar 14 into the housing 2 and supports the collar 14 not to drop out of the housing 2. The O-ring 16 prevents the housing 2 from rotating as far as possible when the housing 2 is fixed over the aperture 1 of the peg head A.

The inverted ring 15 is elastically attached in an inverted ring fixing groove 2a formed in the inner surface of the opening side of the housing 2.

The string-winding side of the winding shaft 7 is inserted into the aperture 1 formed in the peg head A and the string-fastening portion 6 is provided to project from the aperture 1. The portion of the winding shaft 7, projected from the aperture 1, is inserted through a washer 17 into a cylindrical nut 18 that has an inner threaded portion 18a formed thereon, which is engaged with the outer threaded portion 14b of the collar 14. Thus, the housing 2 is secured on the aperture 1 of the peg head A by means of the collar 14 and cylindrical nut 18.

When the tuning machine thus constructed and assembled is used, a string of the ukulele is attached of the hole 6 in the winding shaft 7 and the screw 12 on the knob 10 is relaxed so that the knob 10 can rotate. That is, when the screw 12 on the knob 10 is loosened from the threaded hole 3d of the pinion shaft 3, the fastening force to the housing 2 is weaken. As a result, the knob can be rotated easily and the knob 10 can be rotated to tune the string. When the knob 10 is rotated, the pinion 3b of the pinion shaft 3 rotates the internal gear 5 with a reduced speed according to the gear ratio, and therefore the winding shaft 7 is rotated at the same speed as that of the internal gear 5. The rotation of the internal gear 5 is transmitted to the string of the ukulele to tune the string finely. Once tuned, a strong engagement of the screw 12 on the knob 10 to the threaded hole 3d of the pinion shaft 3 allows the knob 10 and the flange 3c of the pinion shaft 3 to fasten the housing 2. This can prevent the knob 10 from rotating as far as possible when an unintended touch occurs. The central axes of the winding shaft 7 off-centers from that of the pinion shaft 3. Accordingly, the winding shaft 7 is prevented from inversely rotating even if the string tension changes continuously due to playing and the like by a fixing force from the pinion 3 against the housing 2 and a rotation resistance from the pinion 3 and internal gear 5.

As described above, the tuning machine for use in ukuleles according to the present invention comprises the mechanism, which includes the internal gear and the pinion engaged with each other inside the housing so as to rotate the winding shaft at reduced rotations. Therefore, when compared to the mechanism that employs the sun gear and planet gear, the rotation resistance of the internal gear by the knob is smaller, and the knob can be rotated more smoothly and operatively. In addition, it can make the whole configuration of the tuning machine be compact and light-weighted, without losing the original feature of the ukulele and a low cost to purchase it. Further, as the internal gear and pinion are employed to rotate with a reduced speed, even an inexperienced ukulele player can easily perform fine-tuning of the string with the knob. In addition, the winding shaft cannot rotate in the reverse direction, even if the string tension changes continuously due to playing and the like, and therefore the tuning of the string can be stabilized.

The inverted ring is used as the means for preventing the internal gear of the winding shaft from slipping out of the housing. Therefore, when compared with the peg using a threaded ring for screwing, the manufacturing process can be decreased usefully to reduce the cost, and no relaxation of the string will occur due to vibrations and so forth while using.

Having described the embodiments consistent with the present invention, other embodiments and variations consistent with the invention will be apparent to those skilled in the art. Therefore, the invention should not be viewed as limited to the disclosed embodiments but rather should be viewed as limited only by the spirit and scope of the appended claims.

What is claimed is:

1. A ukulele tuning machine to be mounted on a head stock (A) of a ukulele and inserted into an aperture (1) provided therein, comprising:
a hollow, cylindrical housing (2) having a top plate which has a shaft hole (4) at an off-centered position;
a pinion shaft (3) having a pinion (3b) inside said housing (2) and connecting a tuning knob (10) outside said housing (2), said pinion and said tuning knob being placed interposing said shaft hole (4) of said housing (2) therebetween; and
a string post (7) having one and the other ends and including an internal gear (5) provided at said one end, which can rotatably engage with said pinion (3b) within said housing (2), and a string-fastening portion (6) formed at the other end.

2. The ukulele tuning machine of claim 1, further comprising:
a collar (14) having a flange (3c) contacting the back of said internal gear (5) within said housing (2) and a threaded portion (14b) formed on a cylindrical body receiving said winding shaft (7) therethrough;
a stopper means (15) for preventing said collar from slipping out, which is located and secured inside said housing (2) at the back of said collar (14); and
a cylindrical nut (18) for engaging with said threaded portion (14b) of said collar (14) located inside said peg head (A) to secure said housing (2) on said peg head (A).

3. The ukulele tuning machine of claim 2, wherein said stopper means comprises an inverted ring (15) placed at the back of said collar (14) inside said housing (2).
